(19) United States
(12) Patent Application Publication
(10) Pub. No.: US 2012/0141790 A1
(43) Pub. Date: Jun. 7, 2012

(54) METHOD FOR MANUFACTURING BARIUM TITANATE POWDER AND BARIUM TITANATE POWDER MANUFACTURED BY THE SAME

(75) Inventors: Jung Hwan KIM, Suwon (KR); Jeong Oh HONG, Yongin (KR); Han Seong JUNG, Suwon (KR); Kang Heon HUR, Seongnam (KR)

(73) Assignee: SAMSUNG ELECTRO-MECHANICS CO., LTD.

(21) Appl. No.: 13/077,315

(22) Filed: Mar. 31, 2011

(30) Foreign Application Priority Data
Dec. 2, 2010 (KR) 10-2010-0122087

(51) Int. Cl. B32B 5/16; C01F 11/06; B82Y 40/00; B82Y 30/00

(52) U.S. Cl. 428/402; 423/598; 977/896; 977/773

(57) ABSTRACT

There are provided a method for manufacturing a barium titanate powder and a barium titanate powder manufactured by the same. The method for manufacturing the barium titanate powder according to an exemplary embodiment of the present invention includes: preparing a titanium dioxide (TiO₂) powder having a specific surface area of 90 m²/g or more and a barium carbonate (BaCO₃) powder having a specific surface area of 40 m²/g or more; mixing the titanium dioxide powder, the barium carbonate powder, and a dispersant so as to have a specific surface area of a mixed powder of 50 m²/g or more; performing a primary heat treatment of the mixed powder by decompressing the mixed powder at a temperature where a weight decreasing rate of the mixed powder is equal to or more than 90%; and performing a secondary heat treatment of the mixed powder at a temperature of 850° C. or less.

### CROSS-REFERENCE TO RELATED APPLICATIONS

This application claims the priority of Korean Patent Application No. 10-2010-0122087 filed on Dec. 2, 2010, in the Korean Intellectual Property Office, the disclosure of which is incorporated herein by reference.

### BACKGROUND OF THE INVENTION

1. Field of the Invention

The present invention relates to a method for manufacturing a barium titanate powder and a barium titanate powder manufactured by the same, and more particularly, to a method for manufacturing a barium titanate powder having a uniform particle-size distribution through processes of mixing and grinding a particulate material and a barium titanate powder manufactured by the same.

2. Description of the Related Art

Oxides having a Perovskite structure (for example, a material such as BaTiO₃) are used as a dielectric material of electronic components.

One example of an electronic component which uses the oxides having the Perovskite structure as a dielectric material is a multi layered ceramic capacitor (MLCC).

Recently, as electronic components have come to be high-performance and high-integrated, internal electrodes between dielectric layers, in an electronic component such as an MLCC, are required to be thin and multi-layered.

In the case in which the dielectric layer is thin, when barium titanate, as a main component, has a large particle-diameter, a dielectric green sheet is not compact, the rate of electrical shorts is increased due to a high surface roughness, and reliability of an insulating resistance, and the like is deteriorated.

Accordingly, the barium titanate as the main component is required to have highly-crystallized particles.

Examples of a method of manufacturing the barium titanate powder for the MLCC include an oxalate method, a hydrothermal method, and a solid-phase synthesis method.

In the oxalate method, as the barium titanate is synthesized through the thermal degradation of barium titanyl oxalate as a raw material, and heat treatment at a high temperature is needed in order to synthesize high crystalline barium titanate. Accordingly, it is limited to manufacturing barium titanate having a high crystallinity and a uniform particle distribution.

In the hydrothermal method, as a method of extracting a particle in a liquid phase, since hydroxyl groups are bonded in particle crystalline, the density of a final sintered body is low and the manufacturing cost is high, due to the necessity of using expensive equipment therefor.

Meanwhile, in the case of the solid-phase synthesis method, as a method for manufacturing the barium titanate powder by mixing barium carbonate and titanium dioxide and reacting the mixture through heat treatment at a high temperature, could mass-produce barium titanate powder at low cost; however, it is difficult to control the particle-size of the powder in manufacturing the barium titanate powder.

### SUMMARY OF THE INVENTION

An aspect of the present invention provides a method for manufacturing a barium titanate powder which can be used to mass-produce the barium titanate powder at a low cost using a solid phase synthesis method and manufacture barium titanate particles having a uniform particle-size distribution at a low temperature through processes of mixing/grinding particulate materials, as compared with the related art, and a barium titanate powder manufactured by the same.

According to an aspect of the present invention, there is provided a method for manufacturing a barium titanate powder including: preparing a titanium dioxide (TiO₂) powder having a specific surface area of 90 m²/g or more and a barium carbonate (BaCO₃) powder having a specific surface area of 40 m²/g or more;

mixing the titanium dioxide powder, the barium carbonate powder, a solvent, and a dispersant so as to have a specific surface area of a mixed powder of 50 m²/g or more; performing a primary heat treatment of the mixed powder by decompressing the mixed powder at a temperature where a weight decreasing rate of the mixed powder is equal to or more than 90%; and performing a secondary heat treatment on the mixed powder at a temperature of 850° C. or less.

An average particle-diameter of the barium titanate powder manufactured by the secondary heat treatment maybe 100 nm or less.

A C/A axial ratio of the barium titanate powder manufactured by the secondary heat treatment may be equal to or more than 1.0.

The particle-diameter of the barium titanate powder may be 75 nm to 100 nm.

The C/A axial ratio of the barium titanate powder may be equal to or more than 1.008.

In the mixing, the mixed powder may be mixed so as to have a specific surface area of 70 m²/g or more.

In the mixing, the mixed powder may be mixed by a bead mill method using a bead of 0.1 mm or less.

The dispersant may be at least one of ammonium polycarboxylate-based dispersant and ammonium polyacrylate-based dispersant.

A temperature of the primary heat treatment may be 650° C. to 800° C.

In performing the primary heat treatment, the heat treatment is performed by depression to a pressure of 100 Pa or less.

A temperature of the secondary heat treatment may be 750° C. to 850° C.

A specific surface area of the barium titanate powder manufactured by the primary heat treatment may be equal to or more than 30 m²/g.

According to another aspect of the present invention, there is provided a barium titanate powder manufactured by a solid phase synthesis method, has an average particle-diameter of 100 nm or less, and has a C/A axial ratio of 1.0 or more.

The average particle-diameter may be 75 nm to 100 nm.

A particle-size distribution may satisfy the condition of D99/D50<2.

The C/A axial ratio may be equal to or more than 1.008.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a process flowchart illustrating a method for manufacturing a barium titanate powder according to an exemplary embodiment of the present invention.

FIG. 2 is a graph illustrating a weight decreasing rate depending on a temperature of the mixing powder of titanium dioxide and barium carbonate according to an exemplary embodiment of the present invention.

FIG. 3 is a graph illustrating an X-ray diffraction (XRD) pattern phase of a powder after the first heat treatment according to an exemplary embodiment of the present invention.

FIG. 4 is a scanning electron microscope (SEM) photograph illustrating a barium titanate powder manufactured according to an exemplary embodiment of the present invention.

### DETAILED DESCRIPTION OF THE PREFERRED EMBODIMENT

Hereinafter, Exemplary embodiments of the present invention will now be described in detail with reference to the accompanying drawings.

Further, in describing the present invention, well-known functions or constructions will not be described in detail since they may unnecessarily obscure the understanding of the present invention. In addition, elements having similar functions and operations refer to the same reference numerals.

In addition, unless explicitly described to the contrary, the word “comprise” and variations such as “comprises” or “comprising”, will be understood to imply the inclusion of stated elements but not the exclusion of any other elements.

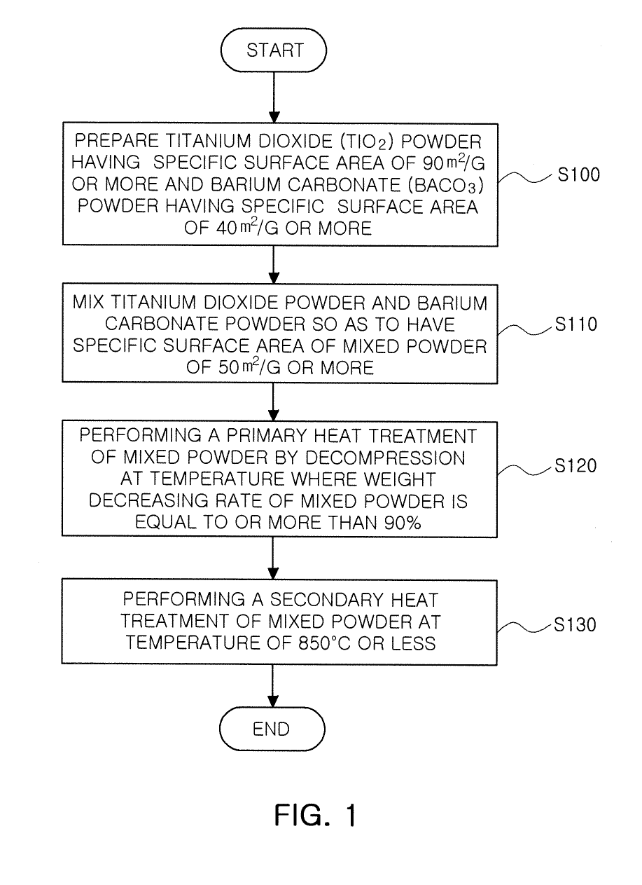

Hereinafter, a method for manufacturing a barium titanate powder and a barium titanate powder manufactured by the same according to an exemplary embodiment of the present invention will be described with reference to FIGS. 1 to 4.

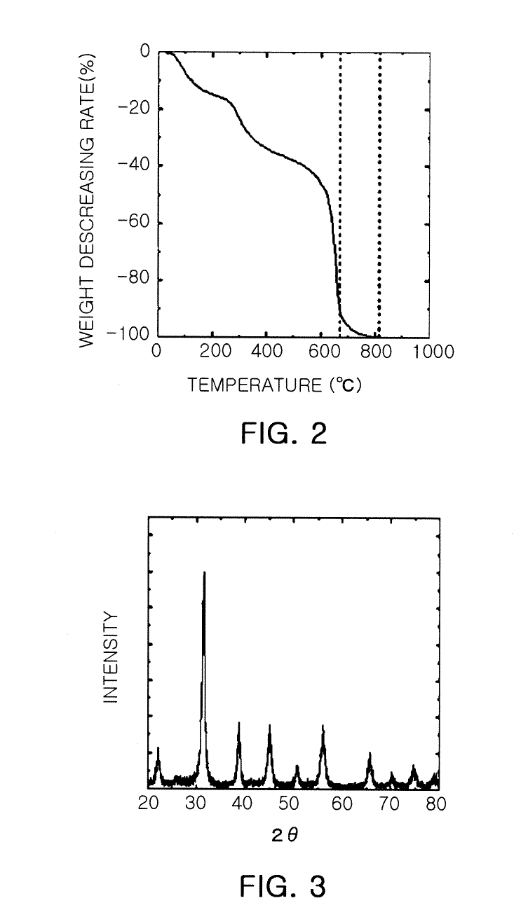

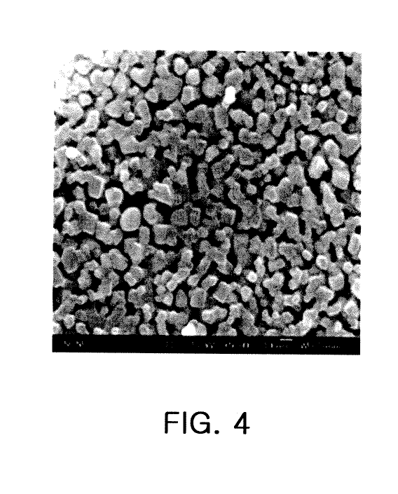

FIG. 1 is a process flowchart illustrating a method for manufacturing a barium titanate powder according to an exemplary embodiment of the present invention, FIG. 2 is a graph illustrating a weight decreasing rate depending on a temperature of the mixing powder of titanium dioxide and barium carbonate according to an exemplary embodiment of the present invention, FIG. 3 is a graph illustrating an X-ray diffraction (XRD) pattern phase of a powder after primary heat treating according to an exemplary embodiment of the present invention, and FIG. 4 is a scanning electron microscope (SEM) photograph illustrating a barium titanate powder manufactured according to an exemplary embodiment of the present invention.

Referring to FIG. 1 illustrating the method for manufacturing a barium titanate powder according to the exemplary embodiment of the present invention, the method for manufacturing the barium titanate powder according to the exemplary embodiment of the present invention includes: preparing a titanium dioxide powder having a specific surface area of 90 m²/g or more and a barium carbonate powder having a specific surface area of 40 m²/g or more (S100); mixing the titanium dioxide powder and the barium carbonate powder so as to have the specific surface area of a mixed powder of 50 m²/g, preferably, 70 m²/g (S110); performing a primary heat treatment on the mixed powder of the titanium dioxide powder and the barium carbonate powder by decompressing the mixed powder at the temperature where a weight decreasing rate of the mixed powder is more than 90% (S120); and performing a secondary heat treatment on the mixed powder at a temperature of 850° C. or less (S130).

In order to manufacture the barium titanate powder, a solid phase synthesis method is used and the titanium dioxide (TiO□) powder and the barium carbonate (BaCO□) powder are prepared by the solid phase synthesis method (S100). The titanium dioxide (TiO□) powder may have the specific surface area of 90 m²/g or more and the barium carbonate (BaCO□) powder may have the specific surface area of 40 m²/g or more.

In order to manufacture a high-crystalline barium titanate-based compound having a uniform particle-size distribution, materials having a large specific surface area maybe used as a raw material. The larger specific surface area of the materials, the smaller particle-size thereof, to thereby make it possible to reduce a reaction temperature in the synthesis process of the barium titanate.

In order to manufacture the barium titanate (BaTiO₃) powder using the titanium dioxide (TiO□) powder and the barium carbonate (BaCO□) powder, the titanium dioxide (TiO□) powder and the barium carbonate (BaCO□) powder may be mixed so as to have a Ba/Ti mole ratio of 0.99 to 1.01.

The titanium dioxide powder, the barium carbonate powder, a solvent, and a dispersant may be mixed, in order that a mixed powder thereof has a specific surface area of 50 m²/g, preferably, 70 m²/g (S110).

The titanium dioxide (TiO□) powder having the specific surface area of 90 m²/g or more and the barium carbonate (BaCO□) powder having the specific surface area of 40 m²/g or more are mixed by adding the solvent and the dispersant.

The dispersant is used in order to evenly disperse the particulate raw material powders into the solvent. As the dispersant, one or more components selected from the group consisting of ammonium polycarboxylate-based dispersant and ammonium polyacrylate-based dispersant, maybe used. However, the dispersant is not limited thereto. In the exemplary embodiment, reaction may be performed without a non-reacted material because synthesis is performed in a state in which the raw material powders are evenly dispersed into the solvent by the dispersant.

The titanium dioxide, the barium carbonate, the solvent, and the dispersant are not limited thereto and may be mixed by a bead mill method.

In order that the mixed powder has a large specific surface area, the mixed powder may be mixed by milling using a bead of 0.1 mm or less for sufficient dispersion and grinding. In addition, the mixed powder may be mixed by dispersing at a grinding velocity of 6m/s or more so as to have a specific surface area of 50 m²/g or more, preferably, 70 m²/g or more.

Since the mixed powder has a specific surface area of 50 m²/g or more, preferably, 70 m²/g or more, the reaction temperature may be lower.

FIG. 2 is a graph illustrating a weight decreasing rate depending on a temperature of the mixing powder of titanium dioxide powder and barium carbonate powder according to an exemplary embodiment of the present invention and the weight decreasing rate illustrates a synthesized degree when the titanium dioxide powder and the barium carbonate powder are synthesized to the barium titanate powder.

That is, when the weight decreasing rate is 100%, it indicates that all of the titanium dioxide powder and the barium carbonate powder all react to synthesize the barium titanate powder.

In order to synthesize the barium titanate powder, thereafter, the mixed powder is primary heat treated by decompressing the mixed powder at the temperature where the weight decreasing rate of the mixed powder is more than 90% (S120). A seed particle of the barium titanate may be generated by forming a barium titanate phase on the surface of the titanium dioxide through the primary heat treating process.

After the primary heat treating process, the seed particle of the barium titanate may grow to a desired size by being secondary heat treated at a higher temperature than the primary heat treating process.

The weight decreasing rate may have different values depending on the specific surface area of the mixed powder. The larger specific surface area of the mixed powder, the better reactivity of the mixed powder has, to thereby make it possible to decrease a temperature at which the weight thereof is reduced by 100%.

Referring to FIG. 2, according to the exemplary embodiment of the present invention, since the mixed powder having the specific surface area of 50 m²/g or more, preferably, 70 m²/g or more is synthesized, the temperature at which the weight thereof is reduced by 100% may be 800° C. and the temperature at which the weight is reduced by 90% may be 650° C.

When the barium titanate is synthesized in the primary heat treating process, since a lot of the non-reactants are remained at the temperature where the weight decreasing rate is less than 90%, the primary heat treating process may be performed at the temperature where the weight decreasing rate is more than 90%.

In addition, according to the exemplary embodiment of the present invention, since the mixed powder has the specific surface area of 50 m²/g or more, preferably, 70 m²/g or more, the reactivity is excellent and the temperature where the weight decreasing rate is more than 90% may be approximately 650° C. to 750° C.

Accordingly, according to the exemplary embodiment of the present invention, in order to perform the primary heat treating process at the temperature where the weight decreasing rate is more than 90%, the primary heat treating process is performed at the temperature of 650° C. to 750° C.

When the primary heat treating process is performed at the temperature where the weight decreasing rate is less than 90%, barium titanate particles grow through the secondary heat treatment in a state that a lot of the non-reactants are remained. Accordingly, since the barium titanate particles do not grow uniformly, it is difficult to synthesize a high crystalline barium titanate powder and repetitively synthesize the barium titanate powder having a uniform particle-size distribution.

Accordingly the primary heat treating process may be performed at the temperature of 650° C. to 750° C., that is, the temperature where the weight decreasing rate is more than 90%.

According to the exemplary embodiment of the present invention, a specific surface area of the barium titanate seed particle manufactured by the primary heat treating process may be 30 m²/g or more and a diameter of the barium titanate seed particle may be 20 nm to 30 nm.

Since the primary heat treating process is performed under the decompression at the temperature where the weight decreasing rate is more than 90%, the titanium dioxide particles can fully react with the barium carbonate particles. Accordingly, the non-reactive titanium dioxide and the barium carbonate phase are extracted in the reactants included in the secondary heat treating process.

Referring to FIG. 3, a XRD pattern phase of reactants after the primary heat treating process may be verified. Herein, θ is a value illustrating an angle incident on a latticed surface and whether any material is included may be verified by verifying peak values according to 2θ value.

In the reactants after the primary heat treating process, when the peak is shown in the range of 25 to 30 degrees of 2θ, it indicates that the barium carbonate particles are remained and when the peak is in the range of 30 to 35 degrees of 2θ, it indicates that the barium titanate particles are included.

In order to control generation of the barium titanate seed particle according to an exemplary embodiment of the present invention, the primary heat treating process may be performed at a pressure of 100 Pa or less. Since the process is preformed under the decompression, a temperature where the barium titanate phase is generated on the surface of the titanium dioxide maybe lower than a temperature in air pressure by 50° C. to 100° C. Accordingly, it is easy to suppress the titanium dioxide from growing.

Referring to FIG. 3, in the reactants after the primary heat treating process, since the peak is not shown in the range of 25 to 30 degrees of 2θ, the barium carbonate powder added at first is not remained and since the peak is shown in the range of 30 to 35 degrees of 2θ, the barium titanate powder is synthesized.

That is, both the titanium dioxide powder and the barium carbonate powder reacting through the primary heat treatment are synthesized to the barium titanate powder.

After the primary heat treating process is completed, the secondary heat treatment may be performed at a temperature of 850° C. or less (S130). The barium titanate seed particle manufactured in the primary heat treating process may grow through the secondary heat treating process.

When a temperature of the heat treatment is more than 850° C. in the secondary heat treating process, the barium titanate particle non-uniformly grows, to thereby make it impossible to reproducibly synthesize the uniform powder having a particle-size of 100 nm or less.

Accordingly, according to the exemplary embodiment of the present invention, the uniform particulate barium titanate powder may be manufactured by performing the secondary heat treatment at a temperature of 850° C. or less.

The barium titanate powder manufactured through the secondary heat treating process may be finely ground through a bead mill process.

FIG. 4 is a scanning electron microscope (SEM) photograph illustrating a barium titanate powder manufactured according to an exemplary embodiment of the present invention.

Since the barium titanate powder manufactured according to the exemplary embodiment of the present invention is heat treated at a temperature of 850° C. or less, the barium titanate particles uniformly grow up, to thereby make it possible to manufacture the barium titanate particles having a particle-diameter of 100 nm or less.

In the case of the solid phase synthesis method according to the related art, since the particle-diameter is difficult to control, it is difficult to synthesize uniform particles having a particle-size.

However, according to the exemplary embodiment of the present invention, since the titanium dioxide powder and barium carbonate powder having a large specific surface area are used and then the mixed powder having a specific surface area of 50 m²/g or more, preferably, 70 m²/g or more is used through the mixing process, it is possible to increase reactivity of the particles.

In particular, in the primary heat treatment process, since the temperature where the weight decreasing rate of the particle is more than 90% is 650° C. to 750° C., all of the titanium dioxide powder and barium carbonate powder react to synthesize the barium titanate seed particle.

Since the barium titanate seed particle can be synthesized without the non-reactants through the primary heat treating process, particles of the barium titanate powder grow through the secondary heat treating process, such that the particles can grow at a temperature of 850° C. or less. Accordingly, it is possible to synthesize the barium titanate powder having a particle-diameter of 75 nm to 100 nm.

In addition, according to the exemplary embodiment of the present invention, since the particles grow at a temperature of 850° C. or less, it is possible to synthesize the barium titanate powder having a uniform average particle-diameter.

It is possible to measure a specific surface area of the manufactured barium titanate powder by a BET method, calculate a C/A axial ratio by analyzing the structure using XRD, and observe the particle-size distribution thereof with the SEM photograph. Typically, it is possible to analyze the particle-size distribution at the rate of D99/D50 through the SEM photograph analysis and analyze a C/A value as a ratio of C axis and A axis of the barium titanate powder through the Rietveld analysis for X-ray diffraction pattern.

The D50 diameter and D99 diameter mean particle-diameters of an accumulate 50% and an accumulate 99% from a particle side of an accumulate particle-size distribution, respectively. According to an exemplary embodiment of the present invention, the particle-size distribution may be illustrated as a ratio value of the accumulate 50% particle-diameter and the accumulate 99% particle-diameter and satisfies the condition of D99/D50<2. It is possible to synthesize the barium titanate powder having a uniform and even particle-size distribution.

In the case of the barium titanate powder manufactured according to the exemplary embodiment of the present invention, the C/A value as a ratio of C axis and A axis may be more than 1.0. The C/A value illustrates crystallization of the particle as an index illustrating a tetragonality of the manufactured barium titanate powder.

According to an exemplary embodiment of the present invention, since the primary heat treating process is performed at the temperature where the weight decreasing rate is more than 90% to manufacture the barium titanate seed particle having a size of 20 nm to 30 nm without the non-reactants and the primary heat treating process is performed at a temperature of 850° C. or less to grow the particle at a low temperature, the crystallization of the particle is improved.

Therefore, in the exemplary embodiment of the present invention, it is possible to manufacture the barium titanate powder having a C/A value of 1.0 or more, more preferably, the barium titanate powder having a C/A value of 1.008 or more.

According to an exemplary embodiment of the present invention, it is possible to manufacture the barium titanate powder using particulate materials at a lower temperature than the related art. Accordingly, it is possible to manufacture the barium titanate powder having a uniform particle-size distribution of D99/D50<2 and the excellent crystalline barium titanate powder having a C/A axial ratio of 1.0 or more, preferably, 1.008 or more.

In addition, according to an exemplary embodiment of the present invention, since the primary heat treating process is performed at the temperature where the weight decreasing rate is more than 90%, the non-reactants are not remained and since the secondary heat treating process is performed a temperature of 850° C. or less, the excellent crystalline particles can be reproducibly manufactured.

Further, since the barium titanate powder manufactured according to an exemplary embodiment of the present invention may have a particle-diameter of 100 nm or less and excellent crystallization, when the barium titanate powder is applied to layered electronic components, a surface roughness of the dielectric layer is smaller, to thereby make it possible to manufacture the dielectric layer having an even surface. Accordingly, it is possible to prevent a short and a defect of an insulating resistance.

As such, since the dielectric layer manufactured using the barium titanate powder has a compact structure and a stable particle-diameter after firing, it is possible to improve reliability of a product and increase the range of an effective firing temperature.

### EXAMPLE

In order to manufacture the barium titanate powder according to an exemplary embodiment of the present invention, first, a titanium dioxide having a specific surface area of 90 m²/g and a barium carbonate having a specific surface area of 40 m²/g were prepared. They were measured so as to have a Ba/Ti mole ratio of 1.002 and a solvent of 200 parts by weight and a dispersant of 4 parts by weight were added and mixed in the measured mixed powder of 100 parts by weight.

At this time, the mixed powder was dried by a spray dryer by being dispersed through a bead mill process using a bead of 0.05 mm.

At this time, a specific surface area of the dried mixed powder measured by a BET method was 77 m²/g. In addition, according to a Thermogravimetry-Differential Thermal Analysis (TG-DTA) analysis result of the mixed powder, a temperature at which the titanium dioxide powder and the barium carbonate reacted by 100% to be mixed to the barium titanate powder was 820° c.

When the primary heat treating process was performed under the mixing temperature of 700° C. and the mixing pressure of 100 Pa for one hour, a specific surface area of the generated barium titanate seed particle was 36 m²/g. In addition, the barium titanate powder having a specific surface area of 8.9 m²/g was synthesized by the secondary heat treating process performed at 810° C. for three hours.

In the barium titanate powder synthesized by the secondary heat treating process, a specific surface area of the powder was measured by a BET method, a C/A axial ratio was calculated through the Rietveld analysis for X-ray diffraction pattern, and the particle-size distribution was observed through a SEM photograph.

A D50 diameter of the barium titanate powder synthesized according to the exemplary embodiment of the present invention was 100 nm, and a D99 diameter was 195 nm. Accordingly, it was possible to manufacture the even barium titanate powder having a particle-size of D99/D50<2.

In addition, the excellent crystalline barium titanate powder having a C/A axial ratio of 1.0086 was synthesized.

As set forth above, the present invention provides a method for manufacturing a barium titanate powder which can mass-produce the barium titanate powder at a low cost using a solid phase synthesis method and manufacture barium titanate particles having a uniform particle-size distribution at a low temperature through processes of mixing/grinding particulate materials, as compared with the related art and a barium titanate powder using the same.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for manufacturing a barium titanate powder, comprising:
preparing a titanium dioxide (TiO₂) powder having a specific surface area of 90 m²/g or more and a barium carbonate (BaCO₃) powder having a specific surface area of 40 m²/g or more;
mixing the titanium dioxide powder, the barium carbonate powder, a solvent, and a dispersant so as to have a specific surface area of a mixed powder of 50 m²/g or more;
performing a primary heat treatment of the mixed powder by decompressing the mixed powder at a temperature where a weight decreasing rate of the mixed powder is equal to or more than 90%; and
performing a secondary heat treatment on the mixed powder at a temperature of 850° C. or less.

2. The method of claim 1, wherein an average particle-diameter of the barium titanate powder manufactured by the secondary heat treatment is 100 nm or less.

3. The method of claim 1, wherein a C/A axial ratio of the barium titanate powder manufactured by the secondary heat treatment is equal to or more than 1.0.

4. The method of claim 2, wherein the particle-diameter of the barium titanate powder is 75 nm to 100 nm.

5. The method of claim 3, wherein the C/A axial ratio of the barium titanate powder is equal to or more than 1.008.

6. The method of claim 1, wherein in the mixing, the mixed powder is mixed so as to have a specific surface area of 70 m²/g or more.

7. The method of claim 1, wherein in the mixing, the mixed powder is mixed by a bead mill method using beads of 0.1 mm or less.

8. The method of claim 1, wherein the dispersant is at least one of an ammonium polycarboxylate-based dispersant and an ammonium polyacrylate-based dispersant.

9. The method of claim 1, wherein a temperature of the primary heat treatment is 650° C. to 800° C.

10. The method of claim 1, wherein, in performing the primary heat treatment, the heat treatment is performed by depression to a pressure of 100 Pa or less.

11. The method of claim 1, wherein a temperature of the secondary heat treatment is 750° C. to 850° C.

12. The method of claim 1, wherein a specific surface area of the barium titanate powder manufactured by the primary heat treatment is equal to or more than 30 m²/g.

13. A barium titanate powder, characterized in that:
the barium titanate powder is manufactured by a solid phase synthesis method, has an average particle-diameter of 100 nm or less, and has a C/A axial ratio of 1.0 or more.

14. The barium titanate powder of claim 13, wherein the average particle-diameter is 75 nm to 100 nm.

15. The barium titanate powder of claim 13, wherein a particle-size distribution satisfies a condition of D99/D50<2.

16. The powder of claim 13, wherein the C/A axial ratio is equal to or more than 1.008.
